(19) United States
(12) Patent Application Publication
(10) Pub. No.: US 2007/0172563 A1
(43) Pub. Date: Jul. 26, 2007

(54) Container for a whole egg

(76) Inventors: Henry Markowicz, Yucaipa, CA (US); Michael Rindt, Corona, CA (US)

Correspondence Address: DRUMMOND & DUCKWORTH, Suite 500, 4590 MacArthur Blvd., Newport Beach, CA, 92660, US

(21) Appl. No.: 11/339,252

(22) Filed: Jan. 25, 2006

(51) Int. Cl. A23B 5/005

(52) U.S. Cl. 426/399

(57) ABSTRACT

Packaging for eggs is provided. The package includes a cup-shaped receptacle having four sides, a bottom, an open top and a central cavity. The top includes an annular flange and a peelable cover which covers the opening. The receptacle's length is substantially greater than its width or height so eggs within the receptacle's cavity are positioned on their sides, and the package provides a lower center of gravity than traditional egg cartons.

### BACKGROUND OF THE INVENTION

The present invention relates to packaging. More particularly, the present invention relates to packaging for the storing, transportation and sale of hens' eggs.

Various packages have been developed for the transportation and sale of eggs. For example, the traditional egg carton is a clam-shell construction made of cardboard, Styrofoam or other similar inexpensive materials. Typically, the egg carton holds twelve eggs and correspondingly each clam-shell member includes twelve recesses for receiving the top and bottom of the egg. Unfortunately, such packages are not particularly useful for when selling only one or two eggs. Moreover, the conventional egg carton is not substantially air-tight.

Eggs are susceptible to the adverse effects of oxygen in the atmosphere and eggs begin to deteriorate immediately after being laid. Among the various factors that cause the deterioration of the egg of the evaporation and release of both water and carbon dioxide from the shell. It is therefore desirable that eggs be insulated from the atmosphere as soon as possible. Unfortunately, traditional egg cartons do not provide this type of protection.

Various attempts have been made to distribute eggs in single use or dual use packaging. For example, U.S. Pat. No. 4,842,143 describes a container for storing two deviled egg halves. The construction includes a clam-shell type construction. It is not air tight and the clam-shell construction is sized only for deviled eggs, but not whole eggs.

U.S. Pat. No. 6,086,931 describes an egg package which includes individual cup-shaped receptacles sized for receiving a single egg. The cup-shape receptacles include an open top which is covered by a peelable transparent cover which inhibits the evaporation of water and the escape of carbon dioxide from the egg. Advantageously, the package may be provided in single egg units, or combined to store, transport or sell several eggs at a time.

Unfortunately, the construction shown in U.S. Pat. No. 6,086,931 suffers from several problems. The construction includes a very small base and the egg is positioned with its longitudinal axis aligned vertically. Unfortunately, this construction makes the cup-shape receptacle susceptible to accidentally falling over. Plainly, items as fragile as eggs should not be placed in containers which are prone to toppling.

Thus, there is a significant need for a packaging for eggs that can contain a single egg or deviled eggs.

It would also be desirable to provide a packaging for eggs which was impervious to the atmosphere so as to reduce the eggs' tendency to deteriorate.

It would further be desirable to provide a package which was less prone to inadvertent toppling.

An additional desirable feature of the packaging would be to provide an egg pack which stored a plurality of eggs which were individually packaged so that one or more eggs may be removed without destroying the protection of the remaining eggs.

### SUMMARY OF THE INVENTION

The present invention addresses the aforementioned disadvantages by providing an improved package for whole eggs. The package includes a cup-shaped receptacle. The receptacle includes four sides, a bottom and an open top. Of importance, the length of the package is longer than its width or height. As a result of the receptacle's long length and short height, eggs are positioned within the receptacle so that the eggs' longitudinal axis is horizontal. In other words, an egg is positioned on its side within the container of the present invention as opposed to the egg being positioned vertically as is the case with conventional egg cartons.

The receptacle includes a flange formed around the top's opening. Moreover, the package is closed with a peelable flat cover sheet which hermetically seals to the annular flange surrounding the rim of the receptacle to provide a substantially gas-tight sealed package. Preferably, the receptacle is filled with a substantially inert gas surrounding the egg to inhibit its deterioration. Preferred inert gasses include nitrogen, carbon dioxide and helium.

The package of the present invention may be distributed individually. Alternatively, a pack of individually sealed eggs may be formed by grouping a number of receptacles together. A pack of individually packaged eggs may then be sealed using a single integral cover sheet which is shaped and dimensioned to overlay the array of receptacles. Individual eggs may be withdrawn from individual receptacles by simply peeling back the cover sheet from a single receptacle, leaving other receptacles still fully covered.

Accordingly, it is a principal object of the present invention to provide a package for individually storing eggs.

It is still an additional object of the present invention to provide a package for eggs which is substantially gas-tight for inhibiting the deterioration of eggs.

It is another object of the present invention to provide a packaging which can be distributed in individual units, or which can be grouped together for storing and distributing a plurality of eggs.

It is still a further object of the invention to provide a package which was less prone to inadvertent toppling.

These and other further and more specific objects an advantages of the present invention will be apparent to those skilled in the art from the following detailed description taking in conjunction with the drawings.

### BRIEF DESCRIPTION OF THE DRAWINGS

FIG. 1 is an exploded perspective view illustrating a pack of the present invention including two receptacles individually packaging two eggs;

FIG. 2 is a perspective view of the egg packaging of the present invention;

FIG. 3 is a top plan view of the egg packaging of the present invention;

FIG. 4 is a bottom plan view of the egg packaging of the present invention;

FIG. 5 is a front side view of the egg packaging of the present invention;

FIG. 6 is a rear side view of the egg packaging of the present invention;

FIG. 7 is a left side view of the egg packaging of the present invention; and

FIG. 8 is a right side view of the egg packaging of the present invention.

### DETAILED DESCRIPTION OF THE INVENTION

While the present invention is susceptible of embodiment in various forms, as shown in the drawings and will hereinafter be described the presently preferred embodiments of the invention with the understanding that the present disclosure is to be considered as an exemplification of the invention and it is not intended to limit the invention to the specific embodiments illustrated.

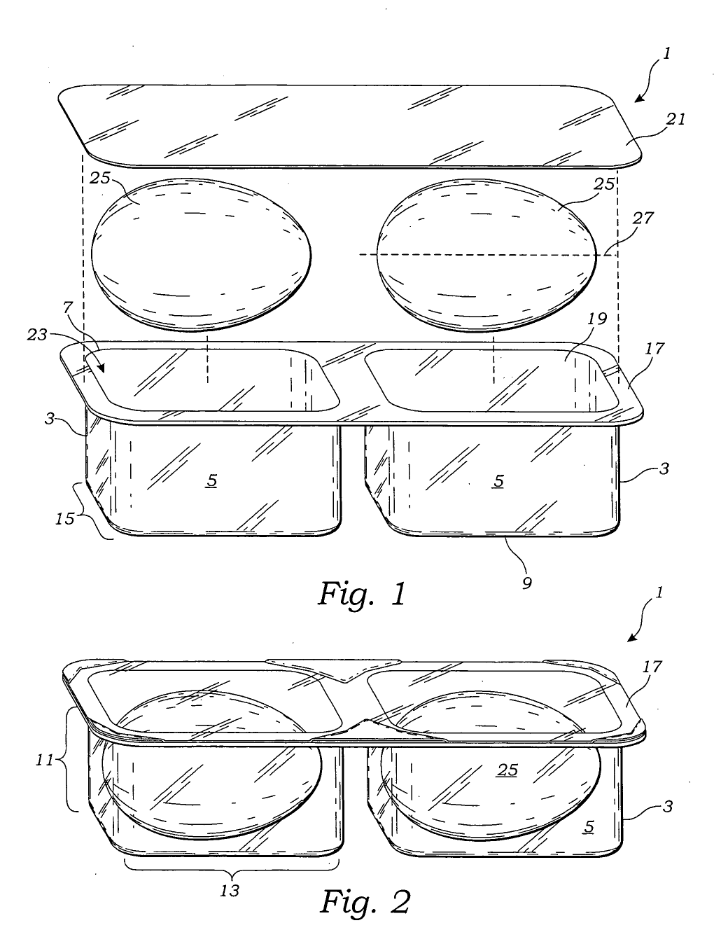

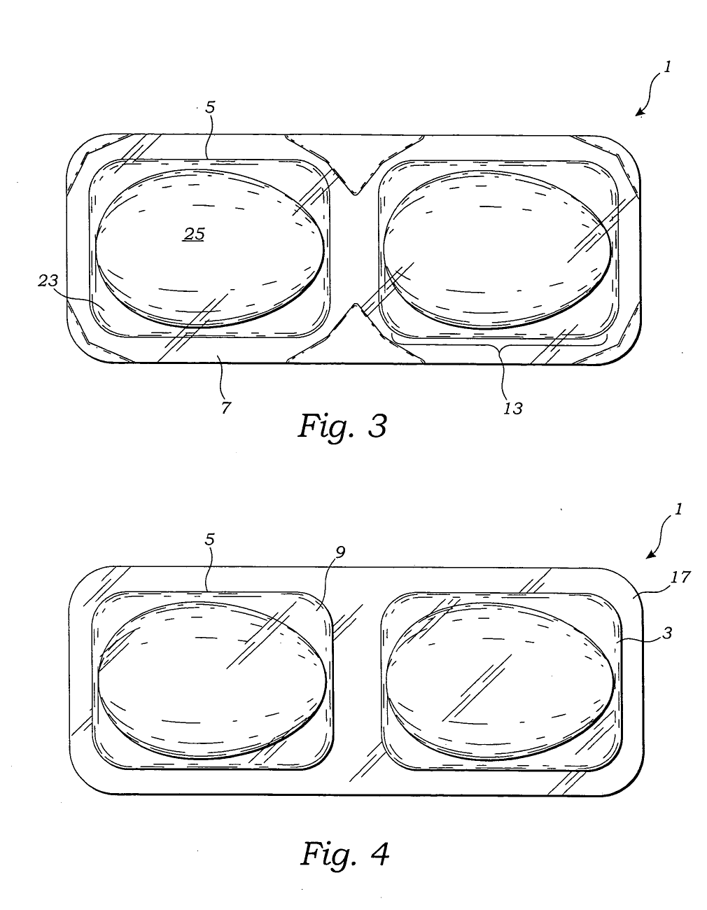

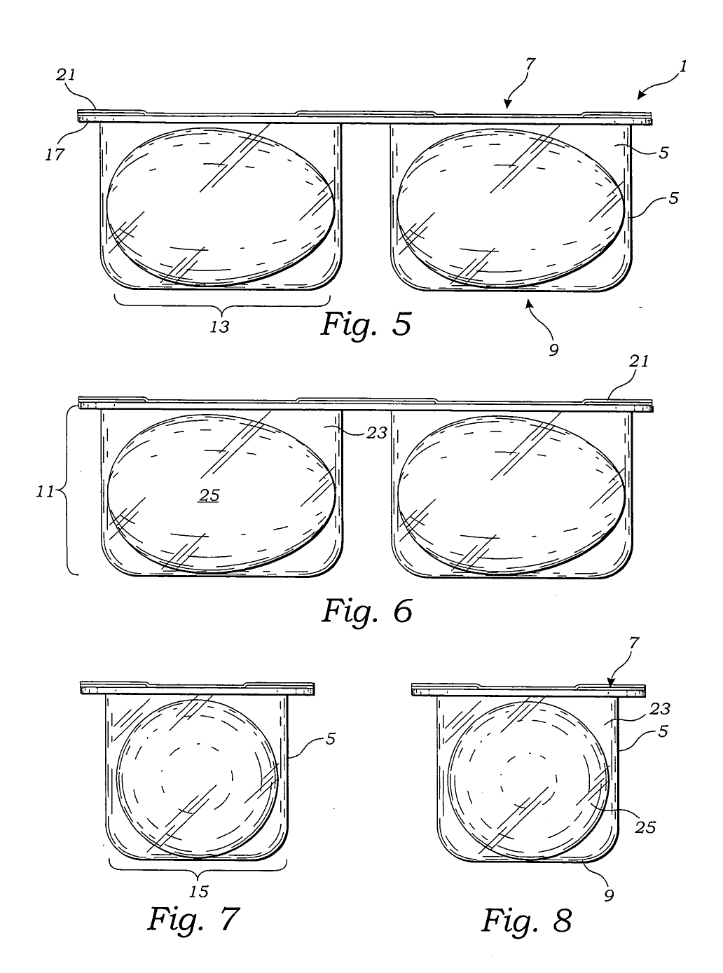

With reference to FIGS. 1-8, the egg package 1 of the present invention includes one or more receptacles 3. Each receptacle 3 includes four sides 5, a top 7 and a bottom 9. The top 7 is open, creating a cup-like structure having a central cavity 23. In addition, the receptacle's top 7 includes a flange 17 surrounding the receptacle's opening 19.

Of importance to the present invention, the receptacle's length 13 is greater than the receptacles' height 11 or width 15. This construction is important because the added length causes eggs within the receptacles cavity 25 to be positioned on their side so that the eggs longitudinal axis 27 (see FIG. 1) is horizontal. As would be appreciated by those skilled in the art, this construction provides a lower center of gravity than if the eggs' longitudinal axis were positioned vertically, as is the case in traditional egg cartons. This lower center of gravity, in conjunction with the receptacles enlarged bottom 9, provides a packaging construction which is much less prone to toppling over. Accordingly, eggs are much less prone to breakage during transportation, storage, and sale.

The egg package 1 of the present invention further includes a cover 21. The cover 21 affixes to the receptacle's flange 17 using an adhesive, as can be selected by those skilled in the art, to provide a hermetic seal between the receptacle and cover. The cover 21 sheet may be made of various materials including translucent plastics or aluminum foil. Preferably, the egg package is provided with a relatively inert gas such as carbon dioxide, nitrogen or helium which surrounds the egg 25 within the cavity 23. The inert gas eliminates oxygen within the package, thereby slowing the eggs deterioration.

The egg package may be constructed to include a single receptacle. Alternatively, as shown in the figures, single receptacles may be grouped together to create an array. The array is then sealed with a single cover sheet 21 to form a pack of individually sealed eggs. Though the figures only illustrate a pack storing two eggs, six-pack or twelve-pack constructions are also preferred.

The package of the present invention is acceptable for storing untreated eggs. In addition, the package is suitable for storing, transporting and marketing hard-boiled eggs as well as whole peeled hard-boiled eggs. Where the egg package is used to distribute whole hard-boiled eggs, salt and pepper packages may also be included either within the egg packages' central cavities 23 or affixed to the exterior of the egg packages' cover 21.

While several particular forms of the invention have been illustrated and described, it will be apparent that various modifications can be made without departing from the spirit and scope of the invention. Accordingly, it is not intended that the invention be limited accept by the following claims. Having described my invention in such terms to enable those persons skilled in the art to understand the invention, recreate the invention, and practice it, and having identified the presently preferred embodiments thereof,

I claim:

1. a package for a whole egg comprising:
a cup-shaped receptacle impermeable to inert gases, said receptacle including a top, a bottom, and four sides which define the receptacle's height which extends from said top to said bottom, the receptacle's width which extends from a first side to an opposing side and the receptacle's length which from a second side to an opposing side, said length being substantially greater than said height and width, and said top including an opening and a planar flange surrounding said opening;
a cover sheet having an adhesive thereon for engaging said flange, said cover sheet providing a manually peelable substantially gas-tight seal for said opening; and
a single whole egg having a longitudinal axis, said egg positioned within said receptacle so that its side rests upon the receptacle's bottom and said egg's longitudinal axis is parallel to said receptacle's length.

2. A package for a whole egg of claim 1 wherein said whole egg is hard boiled.

3. A package for a whole egg of claim 2 wherein said whole egg is peeled.

4. A package for a whole egg of claim 3 further comprising a substantially inert gas within said receptacle.

5. A package for a whole egg of claim 1 further comprising salt or pepper packets positioned within said receptacle.

6. A package for a whole egg of claim 1 further comprising salt or pepper packets affixed to said cover.

7. A package for whole eggs comprising:
a plurality a cup-shaped receptacles impermeable to inert gases, said receptacles positioned adjacent to one another and each including a top, a bottom, and four sides which define the receptacles' height which extends from said top to said bottom, the receptacles' width which extends from a first side to an opposing side and the receptacles' length which extends from a second side to an opposing side, said length being substantially greater than said height and width, and said top including an opening and a planar flange surrounding said opening;
a cover sheet having an adhesive thereon for engaging said flange, said cover sheet providing a manually peelable substantially gas-tight seal for said opening; and
single whole eggs having a longitudinal axis, said eggs positioned within each of said receptacles so that their sides rests upon the receptacles' bottom and said eggs' longitudinal axis are parallel to said receptacles' length.

8. A package for whole eggs of claim 7 wherein said whole eggs are hard boiled.

9. A package for whole eggs of claim 8 wherein said whole eggs are peeled.

10. A package for whole eggs of claim 7 further comprising a substantially inert gas within said receptacles.

11. A package for whole eggs of claim 7 further comprising a plurality of salt or pepper packets positioned within said receptacles.

12. A package for a whole egg of claim 7 further comprising a plurality of salt or pepper packets affixed to said cover.
